(19) United States
(12) Patent Application Publication
(10) Pub. No.: US 2004/0078732 A1
(43) Pub. Date: Apr. 22, 2004

(54) SMP computer system having a distributed error reporting structure

(75) Inventor: Patrick J. Meaney, Poughkeepsie, NY (US)

Correspondence Address: Lynn L. Augspurger, IBM Corporation, 2455 South Road, P386, Poughkeepsie, NY, 12601, US

(73) Assignee: International Business Machines Corporation, Armonk, NY

(21) Appl. No.: 10/277,200

(22) Filed: Oct. 21, 2002

(51) Int. Cl. G06F 11/00

(52) U.S. Cl. 714/57

(57) ABSTRACT

An SMP symmetrical computer system uses a distributed method for reporting errors in a partitioned system. The computer system uses symmetrical, parallel error reporting registers (ERRs), dynamic logging, and interface isolation. It also supports various error types (eg. severe, transient, recovery) with independent reporting hierarchies. The ERR can be programmed to capture first error, who's on first (WOF), or to accumulate errors.

### FIELD OF THE INVENTION This invention relates to symmetrical computer systems, and particularly to a system enabling logging errors in a recoverable system.

### RELATED APPLICATIONS

These co-pending applications and the present application are owned by one and the same assignee, International Business Machines Corporation of Armonk, N.Y.

The descriptions set forth in these co-pending applications are hereby incorporated into the present application by this reference.

Trademarks: S/390 and IBM® are registered trademarks of International Business Machines Corporation, Armonk, N.Y., U.S.A. Other names may be registered trademarks or product names of International Business Machines Corporation or other companies.

### BACKGROUND

As SMP computer systems increase in complexity and density, the reliability would tend to get worse. However, the designs also have more recovery logic to help mitigate the effects of higher failure rates. This means that systems will periodically have errors without going down. However, it is important for the system diagnostics to monitor recovery actions to determine if more severe problems are expected in the future.

In some computer systems where there is employed a network of processors, as opposed to an SMP or symmetrical multiprocessing computer processing systems, a multiprocessing computer system can have a plurality of processing nodes and a global bus network interconnecting the nodes, where a system interface is provided for receiving transactions initiated by one of the processors on a local bus which are destined to remote nodes. In U.S. Pat. No. 6,401,174: “Multiprocessing computer system employing a cluster communication error reporting” of Sun Microsystems, Inc., Palo Alto, Calif., the system interface includes a plurality of error status registers configured to store information regarding errors associated with transactions conveyed upon the global bus network, and a separate error status register is provided for each of the processors.

In the prior art, some systems used checkers that determined certain failures in a system, see for instance, IBM Technical Disclosure Bulletin, vol. 37, No. 02A, February, 1994, “Control Error Checker”. In IBM SMPs, these checkers sometimes had a ‘local mask’ control to allow that checker to be reported or blocked. Checkers were often bundled (ie. OR'ed) into signals that fed a common Error Reporting Register (ERR) which would lock when the error occurred. Accompanying this ERR was often a ‘global mask’ that could be used to ignore certain classes of error conditions.

Earlier IBM 390 systems had the means to escalate errors to higher severity levels, count recovery events, or reset the ERR.

### SUMMARY OF THE INVENTION

In accordance with the preferred embodiment of the invention an SMP symmetrical computer system uses a distributed method for reporting errors in a partitioned system. The computer system uses symmetrical, parallel error reporting registers (ERRs), dynamic logging, and interface isolation. It also supports various error types (eg. severe, transient, recovery) with independent reporting hierarchies. The ERR can be programmed to capture first error, who's on first (WOF), or to accumulate errors.

One aspect of the invention is the use of distributed error reporting registers (ERRs) in a symmetrical multiprocessor or SMP which forms part of a distributed multiprocessor system. These ERRs have the ability to either accumulate error conditions (in the case of a recoverable error) or to lock-up (for severe conditions). There is also the ability to cross-lock the various portions of the distributed system.

Another aspect of the invention is the use of various checker latch configurations, depending on the type of error. For instance, transient error latches do not hold, but instead have a separate latch for monitoring an event.

Another aspect of the invention involves the use of multiple hierarchies in the ERR structure. There is a hierarchy for ‘hard’ (ie. severe) errors which cause a system checkstop. There is a separate hierarchy for ‘soft’ or transient errors to aid in efficiently logging error results. There is also hierarchy for recoverable errors that is used to log-out and act on various recoverable errors.

The invention allows for hardware or code intervention when a device is beginning to fail. For instance, in a multiple-node SMP environment, if a nodal interface starts to fail at a particular rate (eg. correctable errors), a recalibration event may be issued; an interface degrade may result; or a service call may be made to manually intervene. This is accomplished using checkers at key points along paths to identify the failing elements.

Another aspect of the invention includes an indexed means for logging out the ERR data.

These and other improvements are set forth in the following detailed

description. For a better understanding of the invention with advantages and features, refer to the description and to the drawings.

### DESCRIPTION OF THE DRAWINGS

FIG. 1 illustrates prior art Common Error Reporting Register (ERR) circuitry; while

FIG. 2 illustrates a distributed ERR system with cross-locking; while

FIG. 3 illustrates a dynamic, indexed ERR logging system; while

FIG. 4 illustrates parallel ERR hierarchies for severe, transient, and recoverable errors; while

FIG. 5a illustrates a severe error checker configuration; while

FIG. 5b illustrates a transient error checker configuration; while

FIG. 5c illustrates a recovery error checker configuration; while

FIG. 6 illustrates a multiple-node configuration for checking for failing interfaces; while

FIG. 7 illustrates programmable switch circuitry for controlling first-error capture versus accumulation of checker information.

Our detailed description explains the preferred embodiments of our invention, together with advantages and features, by way of example with reference to the drawings.

### DETAILED DESCRIPTION OF THE INVENTION

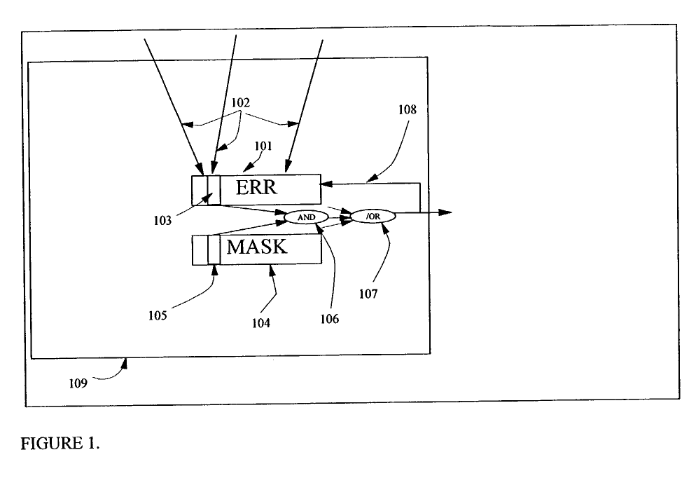

Turning to FIG. 1, notice that prior art error reporting logic, 109, contains an error reporting register (ERR), 101, which collects error conditions, 102, into individual ERR bits, 103. There is also an error reporting mask register (MASK), 104, which contains a global mask bit, 105, for each ERR bit, 103. Said global mask bit, 105, is used to block (or allow) said individual ERR bit, 103, using AND circuit, 106, and ORing the results of these ANDs circuits, 106, into an OR circuit, 107, thereby generating the ERR ANY CHECK signal, 108, which is also used to lock the ERR, 101, from receiving new data.

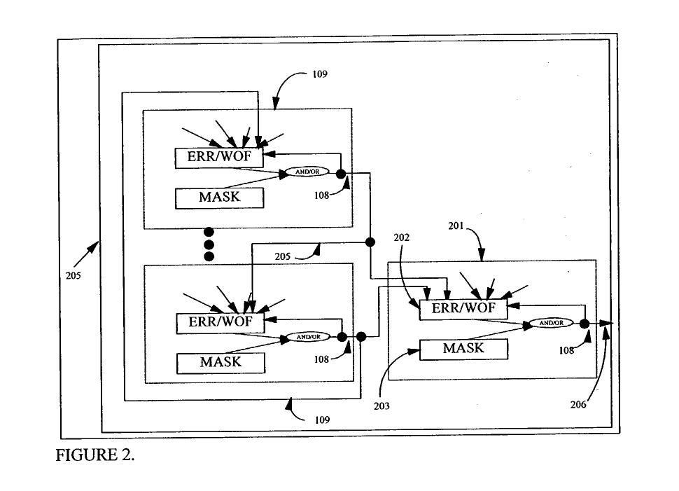

Turning to FIG. 2, notice that the new art allows for a distributed ERR system, 205, which is made up of a multiplicity of error reporting logic circuits, 109, each with said ERR ANY CHECK signals, 108, connected to other error reporting logic circuits, 109, through distributed lock signals, 205. Additionally, there may be a higher level of hierarchy for the distributed ERR to help track system errors more efficiently. To accomplish this, another copy of the error reporting logic circuits, 109, is created. This is referred to as the top-level ERR logic, 201. This contains a top-level ERR, 202, and a top-level MASK register, 203, similar to the error reporting logic, 109, used for lower-levels of hierarchy. The top-level ERR ANY CHECK signal, 206, represents the ERR ANY CHECK signal, 108, of the top-level ERR logic, 201, and indicates if there are any errors on the chip.

Within an SMP computer system, it is often important to have built-in recovery logic as well as code to support the machine. Depending on the nature of the errors, different recovery may be invoked. For instance, if there is an exposure to the integrity of the data, the computer would often need to checkstop. This is referred to as a SEVERE error. There may be other errors which are entirely recoverable (eg. correctable errors as part of an error correction code scheme in a cache machine). Here, the checkers are considered TRANSIENT. They may come up, but should later go away due to their ‘soft’ nature. Another classification of error is active RECOVERY errors. For instance, if a central processor experiences an error, it may be worthwhile to stop that processor, recover the jobs that processor was working on, and to either restart that processor or to move the jobs to another processor. These errors are considered RECOVERY errors.

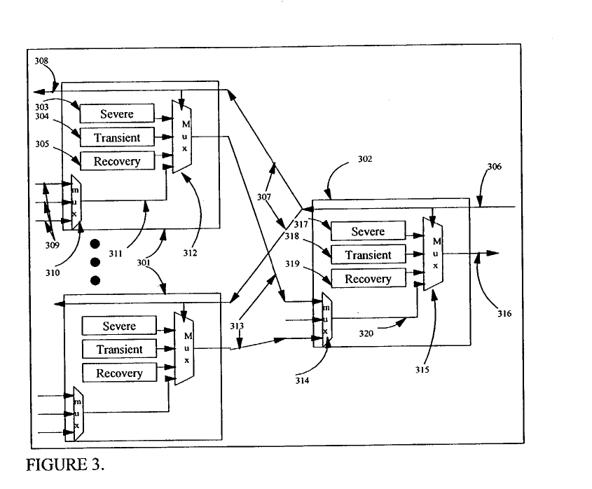

Turning to FIG. 3, there is a distributed ERR system comprising distributed error reporting register (ERR) logic, 301, and top-level ERR logic, 302. (There may be lower levels of hierarchy as well). Within the distributed ERR logic, 301, there is a local severe ERR, 303, local transient ERR, 304, and local recovery ERR, 305. There may also be a global severe ERR, 317, global transient ERR, 318, and global recovery ERR, 319 within the top-level ERR logic, 302. When the system is operating, it may be necessary to access any or all the ERRs in the system. To accomplish this, an ERR request address, 306, is supplied to the top-level ERR logic, 302. That address is supplied to the distributed ERRs, 301, using level 1 address distribution bus, 307. This in turn is distributed to any lower level hierarchies using level 2 address distribution bus, 308, and so on.

If the address targets the top-level of hierarchy, the top-level final mux, 315, is used to select the appropriate register (global severe, 317, global transient, 318, or global recovery, 319) onto the global ERR data return path, 316.

Likewise, if the address targets one of the registers in the distributed ERR logic, 301, the local final mux, 312, is used to select the appropriate register (local severe ERR, 303, local transient ERR, 304, or local recovery ERR, 305) onto the local ERR data return path, 313. The addressed local return path, 313, is selected onto the global ERR data return path, 316, using the top-level initial mux, 314, and top-level final mux, 315.

If the address targets a lower level of hierarchy, the lower hierarchy similarly returns the data onto lower-level hierarchy ERR data return buses, 309, which is selected onto global ERR data return path, 316, using local initial mux, 310, local internal data return path, 311, local final mux, 312, local return path, 313, global initial mux, 314, global internal data return path, 320, and global final mux, 315.

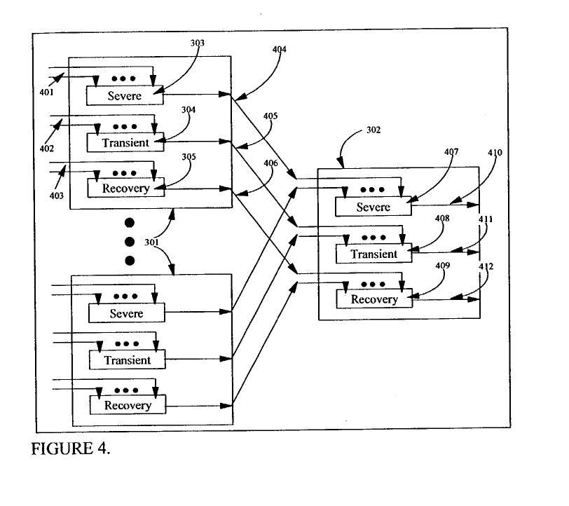

Turning to FIG. 4, there is a distributed ERR system comprising distributed second-level error reporting register (ERR) logic, 301, and top-level ERR logic, 302. (There may be lower levels of hierarchy as well). Within the distributed ERR logic, summaries of lower-level severe errors, 401, are reported to the second-level severe ERR, 303. The second-level severe ERR summary, 404, is reported to the top-level severe ERR, 407, and the top-level severe ERR summary, 410, is available to determine that a severe error exists.

Likewise, summaries of lower-level transient errors, 402, are reported to the second-level transient ERR, 304. The second-level transient ERR summary, 405, is reported to the top-level transient ERR, 408, and the top-level transient ERR summary, 411, is available to determine that a transient error exists.

Likewise, summaries of lower-level recovery errors, 403, are reported to the second-level recovery ERR, 305. The second-level recovery ERR summary, 406, is reported to the top-level recovery ERR, 409, and the top-level recovery ERR summary, 412, is available to determine that a recovery error exists.

While only three types of errors are shown, there can be other types of errors reported in a similar fashion. Also, there may be several parallel hierarchies of each kind. For instance, if there are eight processor cores in a machine, each may have its own hierarchy of recovery ERRs specific to that CP. Therefore, the recovery summary can be used to kick off a recovery event based on an error anywhere in the hierarchy.

Also, it is assumed that, like the prior art, mask registers may be used throughout the distributed hierarchy to block any errors that are not desired to be reported. Sometimes it is beneficial to report the unmasked results as well as the masked results up through the hierarchy. For instance, correctable errors on an interface are considered transient errors. The errors get corrected by hardware and there is no need to stop the machine or perform maintenance on the machine. Since these errors are usually blocked from the hierarchy (because they do not cause a system checkstop), there is often no indication from the top-level that the error occurred. However, by reporting the unmasked version of the summaries as well, there can be an indication that some error occurred. The related hierarchy registers can be logged out. This summary helps to save time by logging out registers only when the summary indicates a new error came up. The presence of the interface checker can be monitored and if it is too frequent, a maintenance action can potentially result.

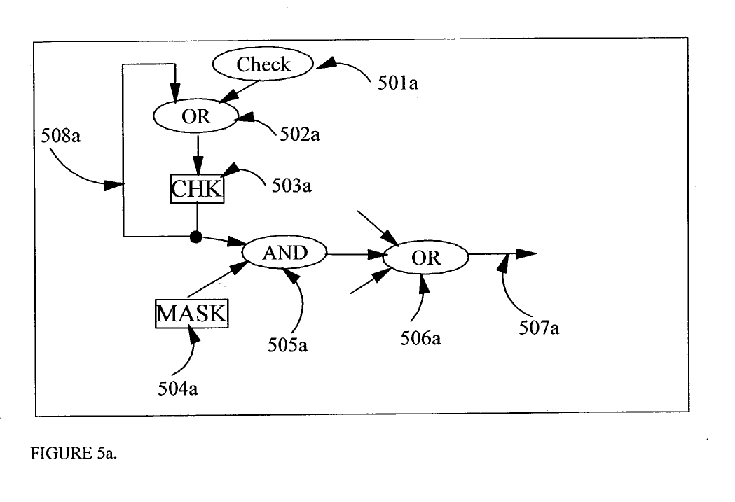

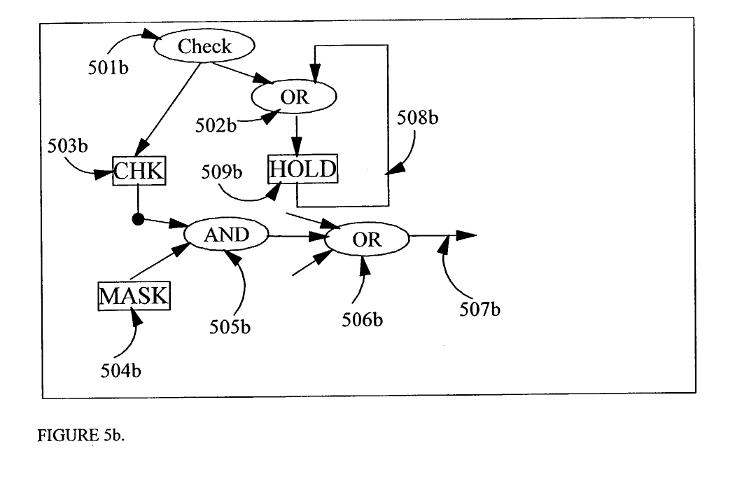

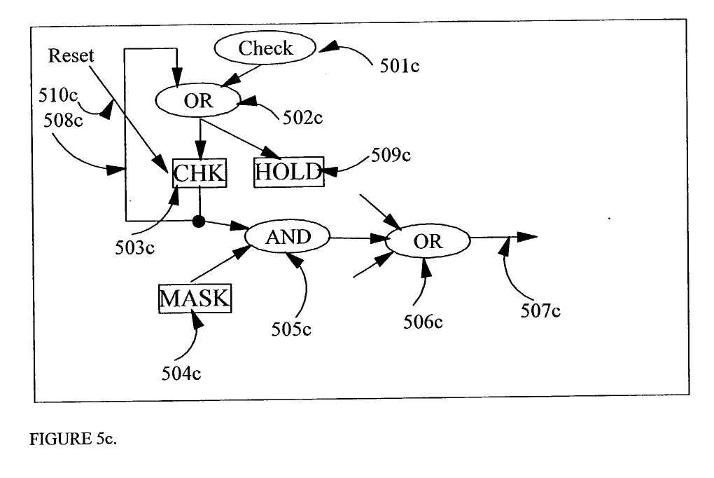

FIG. 5a, 5b, and 5c show three different types of checkers, severe, transient, and recovery. These configurations help to meet needs of reporting, debugging, and ignoring errors with minimal use of logic and registers.

In these cases, there is always a register for reporting the error. There is also a mask register that can be used to block, or ignore, the error. This mask register can be shared (to minimize circuits) with similar checkers to block a group of checkers. There is also at least one register which will keep a permanent history of the event for debug purposes. For recovery errors, there is also the ability to hold the history of the event temporarily during the recovery period, in case recovery is not successful. This will be described in more detail for each checker type.

Turning to FIG. 5a, depicted is an example of a severe error checker configuration. New check condition from severe check logic, 501a, is ORed with previous severe check information, 508a, using OR circuit, 502a, to update severe checker register, 503a. The output of severe checker register, 503a, is ANDed with the severe checker mask, 504a, using AND circuit, 505a, the result getting ORed with other severe checkers into severe error bundle signal, 507a, using OR circuit, 506a. Since severe checkers normally stop the machine immediately, there is never a need to reset the error condition. Therefore, there is only a need for one register, the severe checker register, 503a, to report and hold the error, in addition to whatever mask register support is needed.

Turning to FIG. 5b, depicted is an example of a transient error checker configuration. Notice that there is an additional transient hold register, 509b. A new check condition from transient check logic, 501b, is sent directly to transient checker register, 503b. The output of transient checker register, 503b, is ANDed with the transient checker mask, 504b, using AND circuit, 505b, the result getting ORed with other transient checkers into transient error bundle signal, 507b, using OR circuit, 506b. A new check condition from transient check logic, 501b is also ORed with previous transient check information, 508b, using OR circuit, 502b, to update transient hold register, 509b. Notice that the transient checker register, 503b, returns to zero once the error goes away, thereby causing the transient error bundle signal, 507b, to also drop. However, transient hold register, 508b, continues to hold so the error will be known to have occurred.

Turning to FIG. 5c, depicted is an example of a recovery error checker configuration. Notice that there is also an additional recovery hold register, 509c. A new check condition from recovery check logic, 501c, is ORed with previous recovery check information, 508c, using OR circuit, 502c, to update both recovery checker register, 503c, and recovery hold register, 509c. The output of recovery checker register, 503c, is ANDed with the recovery checker mask, 504c, using AND circuit, 505c, the result getting ORed with other recovery checkers into recovery error bundle signal, 507c, using OR circuit, 506c. Also, unlike the severe error configuration, there is the ability to asynchronously reset the recovery checker register, 503c, using recovery reset signal, 510c, when the recovery event is completed. Because of this reset, there is a recovery hold register, 509c, so the error will be known to have occurred.

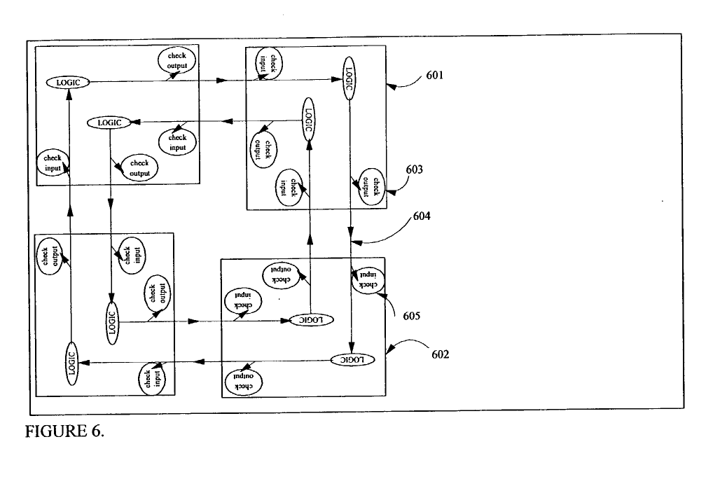

Depicted in FIG. 6 is a multiple-node computer system. In order to isolate interface failures, it is important to capture error information on both sides of the interface. For example, data originates on driving node, 601, is checked by driving checking logic, 603, is transferred on ring bus, 604, is checked by receiver checking logic, 605, and is available on the receiving node, 602. The checker information can be logged using reporting and logging aspects of this invention. Upon analysis, if the driving checking logic, 603, detects an error, only the driving node, 601, is considered faulty, even if the receiver checking logic, 605, also detects an error. However, if only the receiver checking logic, 605, detects an error and there was no error detected by the driving checking logic, 603, both nodes may be faulty, or the connections between these nodes. For that case, a replacement strategy must be determined. For example, 1. Test the nodes, if defect, only replace that node. 2. If neither faulty, assume transient error. Replace the one with more logic and probability of failure (or replace both simultaneously).

There are times when the ERR is needed to capture the first error condition. There are also times when the ERR is used to accumulate errors (eg. transient errors). Since transient error bundle signals are only present while the errors are present, the ERR would need to hold the data until it gets reported. Even if an ERR bit is masked from causing the machine to checkstop, the hold condition is useful for replacement strategies. Therefore, this invention provides for a programmable switch to change the ERR from a “who's on first” (WOF) to a cumulative error register.

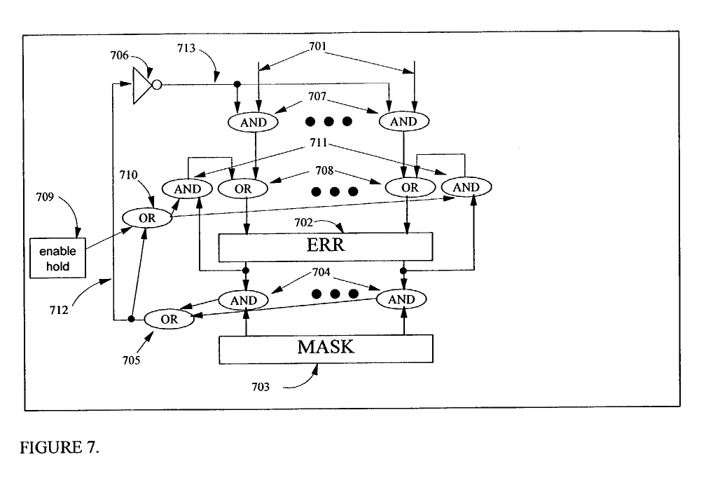

Turning to FIG. 7, notice that there is an ERR, 702, which is initially all zero. Each bit of the ERR, 702, is ANDed with the corresponding bit of the mask register, 703, using AND circuits, 704, the results of which are ORed with OR circuit, 705, to yield ERR lock signal, 712. Since the ERR is initially all zero, this ERR lock signal, 712, is initially zero as well, causing the ERR sample signal, 713, to be active, through inverter circuit, 706. Checker bundle signals, 701, may become active and propagate through blocking AND circuits, 707, and holding OR circuits, 708, thereby setting a corresponding bit of the ERR, 702. This bit will hold its value under three conditions:

1. Checker bundle signal, 701, remains active while ERR sample signal, 713, remains active. This is the case where the checker is holding the checker bundle signal, 701. This would normally be true for severe or recovery checkers. However, transient errors would normally not remain active.

2. ERR lock signal, 712, comes up (due to this checker or another checker). The ERR lock signal, 712, will become active and propagate through control OR circuit, 710, thereby enabling feedback hold AND circuit, 711, to propagate the corresponding bit of the ERR, 702, back through holding OR circuit, 708, thereby holding that bit of the ERR. Once the ERR lock signal, 712, comes up, it also blocks new incoming checker bundle signals, 701, from setting the ERR, 702, because the ERR sample signal, 713, drops and blocks propagation through blocking AND circuits, 707.

3. The enable hold register programmable switch, 709, is active. The enable hold register programmable switch, 709, propagates through control OR circuit, 710, enabling feedback hold AND circuit, 711, to propagate the corresponding bit of ERR, 702, back through holding OR circuit, 708, thereby holding that bit of the ERR.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In an SMP computer system, comprising:
a plurality of symmetrical multiprocessors with error detection, and
an apparatus for a distributed error reporting having
a plurality of error reporting registers, and
a global error reporting register responsive to the plurality of error reporting registers.

2. In an SMP computer according to claim 1, wherein said apparatus for distributed error reporting further includes
cross-locking signals representing the summary of one or more of said plurality of error reporting registers coupled into one or more of said plurality of error reporting registers.

3. In an SMP computer according to claim 1, further comprising:
means to log out said error reporting registers while the SMP computer system is still running.

4. In an SMP computer according to claim 1, wherein said apparatus for a distributed error reporting further comprises:
separate distribution hierarchies for different classes of errors detected to report severe, transient, and recoverable errors.

5. In an SMP computer according to claim 1, further comprising:
a severe error checker latch, which holds its value when set, and
a bundle signal to report one or more severe error checker conditions, and
a mask latch, and
logic to block the severe error checker latch from setting the bundle signal based on the mask latch.

6. In an SMP computer according to claim 4, further comprising:
a severe error checker latch, which holds its value when set, and
a bundle signal to report one or more severe error checker conditions, and
a mask latch, and
logic to block the severe error checker latch from setting the bundle signal based on the mask latch.

7. In an SMP computer according to claim 1, further comprising:
a transient error checker latch, and
a bundle signal to report one or more transient error checker conditions, and
a mask latch, and
logic to block the transient error checker latch from setting the bundle signal based on the mask latch, and
a transient error summary latch, which holds its value once set, indicating that a transient error occurred.

8. In an SMP computer according to claim 4, further comprising:
a transient error checker latch, and
a bundle signal to report one or more transient error checker conditions, and
logic to block the transient error checker latch from setting the bundle signal based on the mask latch, and
a transient error summary latch, which holds its value once set, indicating that a transient error occurred.

9. In an SMP computer according to claim 1, further comprising:
a recovery error checker latch, which holds its value when set, and
a bundle signal to report one or more recovery error checker conditions, and
a mask latch, and
logic to block the recovery error checker latch from setting the bundle signal based on the mask latch, and
a recovery error summary latch, which holds its value once set, indicating that a transient error occurred, and
a reset signal responsive to the end of a recovery event which resets said recovery error checker latch.

10. In an SMP computer according to claim 4, further comprising:
a recovery error checker latch, which holds its value when set, and
a bundle signal to report one or more recovery error checker conditions, and
logic to block the recovery error checker latch from setting the bundle signal based on the mask latch, and
a recovery error summary latch, which holds its value once set, indicating that a transient error occurred, and
a reset signal responsive to the end of a recovery event which resets said recovery error checker latch.

11. In an SMP computer according to claim 3, an apparatus further comprising:
a first system component,
a second system component,
an interface bus from said first system component to said second system component,
an interface checker latch at the output of said first system component, and
an interface checker latch at the input of said second system component, and
said interface latches feed one or more error reporting registers,
said means to log out said error reporting registers are used to isolate failures to one or both of said system components.

12. In an SMP computer according to claim 1, wherein for an error reporting register (ERR) there is provided a mask register, and an ERR lock signal which is active when any bit of the ERR is not blocked by its corresponding bit in said mask register, and
an ERR hold path is provided to hold the contents of said error reporting register when
the ERR lock signal is active.

13. In an SMP computer according to claim 12, wherein
for an error reporting register (ERR) there is provided
an enable hold latch, and
an ERR hold path to hold the contents of said error reporting register when:
(a) the ERR lock signal is active, or
(b) the enable hold latch is active.

14. In an SMP computer according to claim 13, wherein for an error reporting register (ERR) there is provided
an AND function circuit for blocking new input errors from setting the said ERR when the ERR lock signal is active.

15. In an SMP computer according to claim 13, wherein for an error reporting register (ERR) there is provided control code whereby said ERR is programmed to capture a first error, who's on first (WOF), and for accumulating errors.
